(19) United States
(12) Patent Application Publication
(10) Pub. No.: US 2026/0100764 A1
(43) Pub. Date: Apr. 9, 2026

(54) SIGNAL PROCESSING CIRCUIT, OPTICAL SIGNAL RECEIVING DEVICE, AND SIGNAL PROCESSING METHOD

(71) Applicant: NEC Corporation, Tokyo (JP)

(72) Inventors: Shoma TATENO, Tokyo (JP); Hidemi NOGUCHI, Tokyo (JP)

(73) Assignee: NEC Corporation, Tokyo (JP)

(21) Appl. No.: 19/341,176

(22) Filed: Sep. 26, 2025

(30) Foreign Application Priority Data
Oct. 8, 2024 (JP) 2024-176422

(51) Int. Cl. H04B 10/61

(52) U.S. Cl. CPC H04B 10/614; H04B 10/613; H04B 10/6163; H04B 10/6164; H04B 10/6165

(57) ABSTRACT

A signal processing circuit includes a MIMO filter that performs polarization separation on a reception signal obtained by performing optical sampling reception on optical signals that are polarization multiplexed signals in parallel by using a plurality of local light beams using optical pulses, and a coefficient update unit that updates a coefficient of the MIMO filter based on periodicity based on a parallel number in the optical sampling reception.

### INCORPORATION BY REFERENCE

This application is based upon and claims the benefit of priority from Japanese patent application No. 2024-176422, filed on Oct. 8, 2024, the disclosure of which is incorporated herein in its entirety by reference.

### TECHNICAL FIELD

The present disclosure relates to a signal processing circuit, an optical signal receiving device, a signal processing method, and a program.

### BACKGROUND ART

As a technique for receiving an optical signal, optical sampling reception is known (see, for example, JP 2011-097253 A). Optical sampling reception is a technique of parallelizing a received optical signal into a predetermined parallel number of optical signals and capturing the entire signal by using a plurality of local light beams including optical pulses. By sampling the optical signal with the plurality of optical pulses, it is possible to reduce the speed and the bandwidth of the reception device for receiving the optical sampling signal per lane, and further increase in speed of the optical signal and decrease in cost of the optical reception device can be expected. In the optical sampling reception, the received optical signal is parallelized into, for example, four optical signals. Stated another way, the received optical signal is split into four lanes. Each of the four split optical signals is coherently received by using an optical pulse repeated at a predetermined period in each lane.

In general, the optical pulse output from the light source is delayed by a predetermined delay time according to the lane by the optical delayer, and is input to the coherent receiver of each lane. For example, the optical pulse is delayed in the optical delayer so as to be shifted by ¼ of the repetition period of the optical pulse. At this time, a delay time of an optical pulse used for coherent reception may be shifted between lanes due to device environment or the like. In a case where the delay time of the optical pulse is shifted, the reception signal characteristics are deteriorated.

As a technique for adjusting a timing deviation in optical sampling reception, there are techniques described in J. K. Fischer, et al., “High-Speed Digital Coherent Receiver Based on Parallel Optical Sampling”, Journal of Lightwave Technology, Vol. 29, No. 4, 378-385 (2011) and P. Johannisson, et al., “A Blind Phase Stabilization Algorithm for Parallel Coherent Receivers”, Journal of Lightwave Technology, Vol. 29, No. 24, 3737-3743 (2011). In J. K. Fischer, et al., “High-Speed Digital Coherent Receiver Based on Parallel Optical Sampling”, Journal of Lightwave Technology, Vol. 29, No. 4, 378-385 (2011), timing deviation is adjusted and calibrated by using a reference signal. P. Johannisson, et al., “A Blind Phase Stabilization Algorithm for Parallel Coherent Receivers”, Journal of Lightwave Technology, Vol. 29, No. 24, 3737-3743 (2011) uses spectral linewidths to compensate for timing mismatches.

### SUMMARY

However, J. K. Fischer, et al., “High-Speed Digital Coherent Receiver Based on Parallel Optical Sampling”, Journal of Lightwave Technology, Vol. 29, No. 4, 378-385 (2011) has a problem that it is not possible to adjust the timing deviation during the operation of the system. P. Johannisson, et al., “A Blind Phase Stabilization Algorithm for Parallel Coherent Receivers”, Journal of Lightwave Technology, Vol. 29, No. 24, 3737-3743 (2011) has a problem that a guard band is required and band utilization efficiency is poor.

An example object of the present disclosure is to provide a signal processing circuit, an optical signal receiving device, a signal processing method, and a program capable of compensating for a mismatch between lanes during operation of a reception signal subjected to the optical sampling reception without reducing band utilization efficiency.

A signal processing circuit according to a first example aspect of the present disclosure includes a multi input multi output (MIMO) filter that performs polarization separation on a reception signal obtained by performing optical sampling reception on optical signals that are polarization multiplexed signals in parallel by using a plurality of local light beams using optical pulses, and a coefficient update unit that updates a coefficient of the MIMO filter based on periodicity based on a parallel number in the optical sampling reception.

An optical signal receiving device according to a second example aspect of the present disclosure includes the signal processing circuit, an optical receiver that performs optical sampling reception on the optical signals in parallel by using a plurality of local light beams using the optical pulse, and a combiner that combines a plurality of signals obtained by the optical receiver performing optical sampling reception on the optical signals in parallel, and inputs the combined plurality of signals to the signal processing circuit as the reception signal.

A signal processing method according to a third example aspect of the present disclosure includes
performing, using a multi input multi output (MIMO) filter, polarization separation on a reception signal obtained by performing optical sampling reception on optical signals that are polarization multiplexed signals in parallel by using a plurality of local light beams using optical pulses, and
updating a coefficient of the MIMO filter based on periodicity based on a parallel number in the optical sampling reception.

A program according to a fourth example aspect of the present disclosure causes a processor to execute processes of performing, using a multi input multi output (MIMO) filter, polarization separation on a reception signal obtained by performing optical sampling reception on optical signals that are polarization multiplexed signals in parallel by using a plurality of local light beams using optical pulses, and updating a coefficient of the MIMO filter based on periodicity based on a parallel number in the optical sampling reception.

A signal processing circuit, an optical signal receiving device, a signal processing method, and a program according to the present disclosure can compensate for a mismatch between lanes during operation without reducing band utilization efficiency.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram illustrating a schematic configuration example of an optical signal receiving device according to the present disclosure;

FIG. 2 is a block diagram illustrating a configuration example of a communication system including the optical signal receiving device according to the present disclosure;

FIG. 3 is a block diagram illustrating a configuration example of an optical signal receiver;

FIG. 4 is a waveform diagram illustrating sampling of an optical signal;

FIG. 5 is a block diagram illustrating a configuration example of a MIMO signal processing circuit;

FIG. 6 is a diagram schematically illustrating MIMO filtering processing in a case where m=2;

FIG. 7 is a diagram schematically illustrating MIMO filtering processing in a case where m=4;

FIG. 8 is a flowchart illustrating an operation procedure of the optical signal receiver;

FIG. 9 is a constellation of output signals of the optical signal receiver in a case where the parallel number is 4;

FIG. 10 is a constellation of output signals of the optical signal receiver in a case where the parallel number is 4;

FIG. 11 is a constellation of output signals of the optical signal receiver in a case where the parallel number is 8;

FIG. 12 is a constellation of output signals of the optical signal receiver in a case where the parallel number is 8;

FIG. 13 is a constellation of output signals of the optical signal receiver in a case where there is a gain difference between lanes;

FIG. 14 is a constellation of output signals of the optical signal receiver in a case where there is a gain difference between lanes;

FIG. 15 is a block diagram illustrating a configuration example of a MIMO signal processing circuit;

FIG. 16 is a diagram schematically illustrating MIMO filtering processing;

FIG. 17 is a constellation of output signals of the optical signal receiver in a case where the parallel number is 4; and

FIG. 18 is a block diagram illustrating a configuration example of a signal processing circuit.

### EXAMPLE EMBODIMENT

Prior to describing example embodiments of the present disclosure, an outline of the present disclosure will be described. FIG. 1 is a block diagram illustrating a schematic configuration example of an optical signal receiving device according to the present disclosure. An optical signal receiving device 10 includes an optical receiver 20, a combiner 30, and a signal processing circuit 40. The signal processing circuit 40 includes a MIMO filter 41 and a coefficient update unit 42.

The optical receiver 20 performs optical sampling reception on optical signals, which are polarization multiplexed signals, in parallel by using a plurality of local light beams using optical pulses. The combiner 30 combines a plurality of signals obtained by the optical receiver 20 performing optical sampling reception on the optical signals in parallel. The combiner 30 outputs the combined signal to the signal processing circuit 40.

In the signal processing circuit 40, the MIMO filter 41 is a filter that performs polarization separation on the signal input from the combiner 30, that is, the reception signal. The MIMO filter 41 has a plurality of types of coefficients, and performs MIMO processing based on periodicity based on the parallel number in optical sampling reception. The coefficient update unit 42 updates the coefficients of the MIMO filter 41 based on periodicity based on the parallel number in the optical sampling reception.

In the present disclosure, the coefficient update unit 42 of the signal processing circuit 40 updates the coefficient of the MIMO filter 41 for each coefficient type by using the coefficients of the plurality of types of MIMO filters 41 based on periodicity based on the parallel number in the optical sampling reception. In the present disclosure, the signal processing circuit 40 performs the MIMO processing based on periodicity based on the parallel number in the optical sampling reception using the coefficients of the plurality of types of MIMO filters 41 in the MIMO filter 41 used for the polarization separation. In this way, in the MIMO filter 41, it is possible to compensate for the timing mismatch between the lanes of the signal sampled and received by using the optical pulse in parallel at the same time as the polarization separation.

The signal processing circuit 40 according to the present disclosure can compensate for a timing mismatch without using a special signal such as a reference signal. Therefore, the signal processing circuit 40 can compensate for the timing mismatch during operation of the system. In the present disclosure, it is not necessary to provide a guard band for timing mismatch. Therefore, the signal processing circuit 40 can compensate for the timing mismatch without reducing the band efficiency.

Example embodiments according to the present disclosure will be described hereinafter in detail. In the following description and drawings, omission and simplification are made as appropriate for clarity of description. In each drawing, the same elements and the similar elements are denoted by the same reference numerals, and repeated description is omitted as necessary.

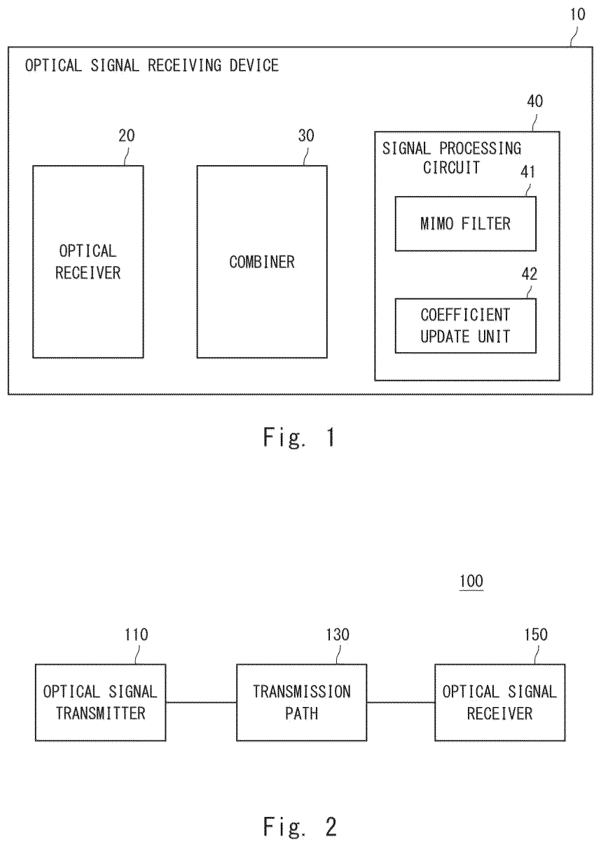

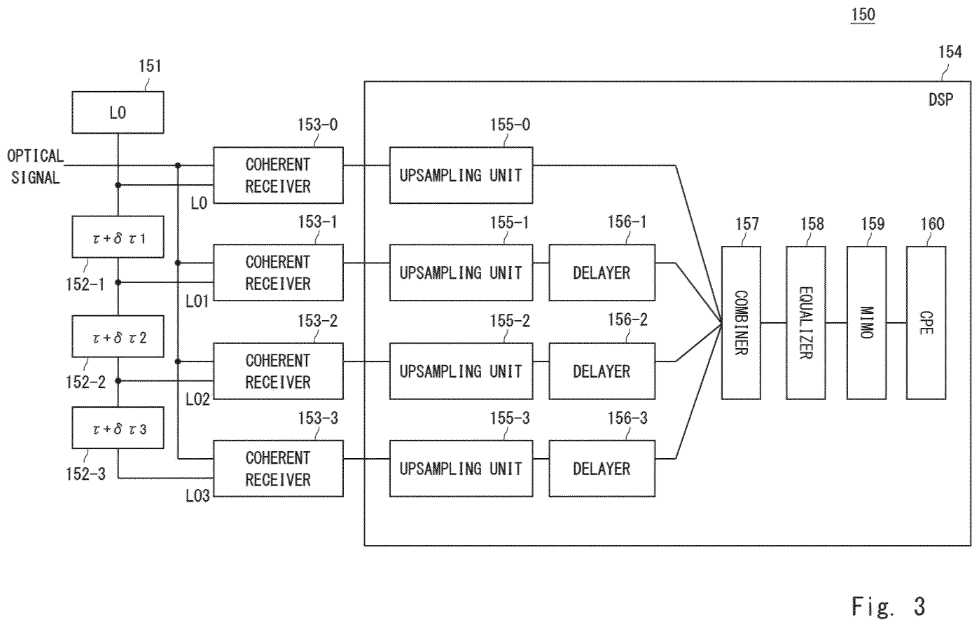

A first example embodiment will be described. FIG. 2 is a block diagram illustrating a configuration example of a communication system including the optical signal receiving device according to the present disclosure. An optical fiber communication system 100 includes an optical signal transmitter 110, a transmission path 130, and an optical signal receiver 150. In the first example embodiment, the optical fiber communication system 100 is assumed to be an optical fiber communication system that adopts a polarization multiplexing multi-level modulation system and performs coherent reception.

The optical signal transmitter 110 generates a polarization-multiplexed optical signal and outputs the generated polarization-multiplexed optical signal to the transmission path 130. The transmission path 130 transmits the polarization-multiplexed optical signal output from the optical signal transmitter 110 to the optical signal receiver 150. The transmission path 130 includes an optical fiber that guides an optical signal. The transmission path 130 includes an optical amplifier that compensates for a propagation loss in the optical fiber. The optical signal receiver 150 receives the polarization-multiplexed optical signal transmitted via the transmission path 130.

FIG. 3 is a block diagram illustrating a configuration example of the optical signal receiver 150. The optical signal receiver 150 includes a local oscillator (LO) 151, optical delayers 152-1 to 152-3, coherent receivers 153-0 to 153-3, and a digital signal processor (DSP) 154. The optical signal receiver 150 is relevant to the optical signal receiving device 10 illustrated in FIG. 1.

In the optical signal receiver 150, an optical splitter such as an optical coupler (not illustrated) splits the optical signal transmitted via the transmission path 130, that is, the polarization-multiplexed optical signal according to the parallel sampling number of the optical signal. In the example of FIG. 3, the parallel number is 4. In the example of FIG. 3, the optical signal is split into four lanes, and the split four optical signals are input to the coherent receivers 153-0 to 153-3 in each lane.

The LO 151 outputs the optical pulse LO at a predetermined repetition period. The LO 151 includes a pulsed light source. The LO 151 includes, for example, a modulator-integrated semiconductor laser. The optical delayer 152-1 delays the optical pulse LO output from the LO 151 and outputs a delayed optical pulse LO1. The optical delayer 152-2 delays the optical pulse LO1 output from the optical delayer 152-1 and outputs a delayed optical pulse LO2. The optical delayer 152-3 delays the optical pulse LO2 output from the optical delayer 152-2 and outputs a delayed optical pulse LO3.

The delay amount of the optical delayer 152-1 is represented by τ+δτ1. The delay amount of the optical delayer 152-2 is represented by τ+δτ2. The delay amount of the optical delayer 152-3 is represented by τ+δτ3. In a case where optical sampling of 2 samples/1 symbol is performed on the optical signal with a baud rate of 32 GBaud, the delay time τ is set to τ=1/(32 G×2)[sec]. δτ1, δτ2, and δτ3 represent variation components that change due to factors such as device environment.

The coherent receivers 153-0 to 153-3 perform coherent detection on the optical signals split in parallel by using optical pulses. In the first example embodiment, the coherent receivers 153-0 to 153-3 sample optical signals in parallel using the optical pulses LO, LO1, LO2, and LO3 as local light beams. For example, in a case where optical sampling of 2 samples/1 symbol is performed on an optical signal having a baud rate of 32 GBaud in 4 parallel, the coherent receivers 153-0 to 153-3 each sample an input optical signal at a cycle relevant to 16 GHz.

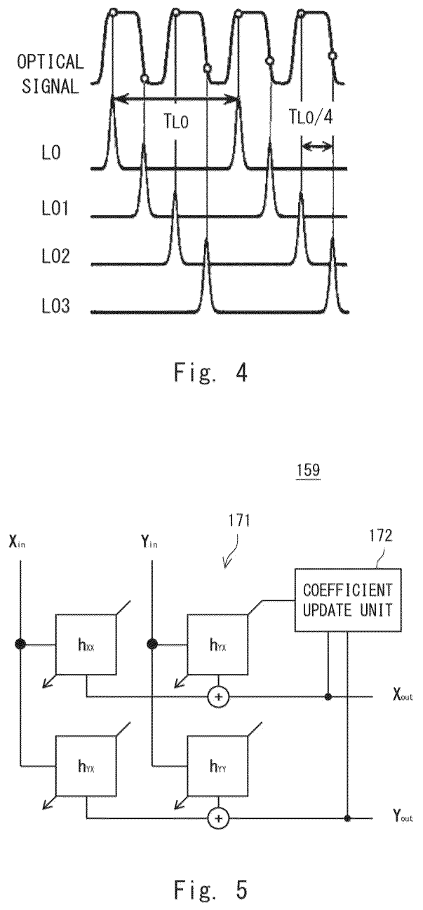

FIG. 4 is a waveform diagram illustrating sampling of an optical signal. The repetition period of the optical pulse output from the LO 151 is defined as TLO. The delay time t given to the optical pulse in the optical delayers 152-1 to 152-3 is set to T_{LO}/4. The optical pulse LO1 is an optical pulse delayed by T_{LO}/4 with respect to the optical pulse LO. The optical pulse LO2 is an optical pulse delayed from the optical pulse LO by 2×T_{LO}/4. The optical pulse LO3 is an optical pulse delayed from the optical pulse LO by 3×T_{LO}/4.

The coherent receiver 153-0 performs coherent detection on the optical signal by using the optical pulse LO output from the LO 151. The coherent receiver 153-1 performs coherent detection on the optical signal by using the optical pulse LO1 output from the optical delayer 152-1. The coherent receiver 153-2 performs coherent detection on the optical signal by using the optical pulse LO2 output from the optical delayer 152-2. The coherent receiver 153-3 performs coherent detection on the optical signal by using the optical pulse LO3 output from the optical delayer 152-3. In FIG. 4, white circles illustrated in the optical signal waveform indicate sampling points of the optical signal.

The coherent receivers 153-0 to 153-3 include a 90° hybrid and a photoelectric converter. The coherent receivers 153-0 to 153-3 output four series of reception signals (electric signals) relevant to I components and Q components of the X polarized wave and the Y polarized wave subjected to coherent detection. The reception signals output in parallel from the coherent receivers 153-0 to 153-3 are converted from analog signals to digital signals by using an analog digital converter (ADC) (not illustrated). The reception signal converted into the digital signal is input to the DSP 154. The LO 151, the optical delayers 152-1 to 152-3, and the coherent receivers 153-0 to 153-3 are relevant to the optical receiver 20 illustrated in FIG. 1.

The DSP 154 performs digital signal processing on the reception signal. The DSP 154 includes upsampling units 155-0 to 155-3, delayers 156-1 to 156-3, a combiner 157, an equalizer 158, a multi-input multi-output (MIMO) signal processing circuit 159, and a carrier phase recovery (CPR) compensator 160. The DSP 154 can be configured as, for example, a device including one or more processors and one or more memories. At least some of the functions of the units in the DSP 154 can be implemented by the processor executing processing according to a command read from the memory. At least some of the functions of each unit in the DSP 154 may be implemented by a dedicated hardware circuit.

The upsampling units 155-0 to 155-3 upsample the reception signals output from the coherent receivers 153-0 to 153-3. The upsampling units 155-0 to 155-3 upsample, for example, a reception signal of 16 GHz into a signal of 64 GHz. More specifically, the upsampling unit 155-0 inserts “0” as a signal relevant to the timings of the optical pulses LO1, LO2, and LO3 into the signal output from the coherent receiver 153-0. The upsampling unit 155-1 inserts “0” as a signal relevant to the timings of the optical pulses LO, LO2, and LO3 into the signal output from the coherent receiver 153-1. The upsampling unit 155-2 inserts “0” as a signal relevant to the timings of the optical pulses LO, LO1, and LO3 into the signal output from the coherent receiver 153-2. The upsampling unit 155-3 inserts “0” as a signal relevant to the timings of the optical pulses LO, LO1, and LO2 into the signal output from the coherent receiver 153-3.

The delayers 156-1 to 156-3 delay the upsampled signals output from the upsampling units 155-1 to 155-3, and adjust the timings of the signals. The combiner 157 combines upsampled reception signals output from the upsampling unit 155-0 and the delayers 156-1 to 156-3. Stated another way, the combiner 157 combines the four reception signals sampled in parallel. The combiner 157 outputs, for example, a complex number signal indicating the I component and the Q component of the X polarized wave and a complex number signal indicating the I component and the Q component of the Y polarized wave to the equalizer 158. The combiner 157 is relevant to the combiner 30 illustrated in FIG. 1.

In the first example embodiment, in order to perform wavelength dispersion compensation, polarization mode dispersion compensation, and polarization separation on the combined reception signal, the optical signal is subjected to optical sampling reception in parallel such that the reception signal is a signal of 2 samples/1 symbol. For example, in a case where the parallel number is 4 and the optical signal is a signal of 32 GBaud, as described above, the optical signals are sampled at a cycle relevant to 16 GHz in the coherent receivers 153-0 to 153-3. In a case where the parallel number is 8, optical signals are sampled at a period relevant to 8 GHz in each of the eight coherent receivers.

The equalizer 158 performs equalization processing for compensating for static distortion on the combined reception signal. The equalizer 158 compensates for static distortion by using, for example, a fixed filter in which coefficients are statically set. The MIMO signal processing circuit 159 includes an adaptive MIMO filter whose coefficients are adaptively controlled. The MIMO signal processing circuit 159 performs, for example, polarization separation, polarization mode dispersion compensation, and frequency characteristics compensation. The CPR compensator 160 performs frequency offset compensation and carrier phase recovery. Processing such as symbol recovery and decoding is performed on the signal output from the CPR compensator 160.

Here, for example, in a case where 813 is not 0 in the optical delayer 152-3, the timing of the optical pulse LO3 is shifted from the timing illustrated in FIG. 4. In that case, the timing of sampling the optical signal in the coherent receiver 153-3 deviates from the timing of the white circle illustrated in FIG. 4, and the sampling intervals of the optical signal are not equal. In a case where the timing of the optical pulse LO3 is shifted, a signal different from the signal acquired at the original sampling point is acquired in the coherent receiver 153-3. Such a shift of the sampling interval is also referred to as a timing mismatch. In the first example embodiment, the MIMO signal processing circuit 159 also performs timing mismatch compensation between lanes.

FIG. 5 is a block diagram illustrating a configuration example of the MIMO signal processing circuit 159. The MIMO signal processing circuit 159 includes a MIMO filter 171 and a coefficient update unit 172. The MIMO signal processing circuit 159 is relevant to the signal processing circuit 40 illustrated in FIG. 1. The MIMO filter 171 is relevant to the MIMO filter 41 illustrated in FIG. 1. The coefficient update unit 172 is associated with the coefficient update unit 42 illustrated in FIG. 1.

The MIMO filter 171 performs polarization separation on the reception signal. The MIMO filter 171 includes a finite impulse response (FIR) filter having a 2×2 butterfly structure to separate two-component polarizations. A tap length of each FIR filter is assumed to be “1”. The MIMO filter 171 has m types of coefficients h₀ to hₘ (sets of coefficients). The MIMO filter 171 applies m types of coefficients to the reception signal based on periodicity based on the parallel number of the optical sampling reception. The value of m is determined according to the parallel number optical sampling reception. For example, in a case where the parallel number is 4, m=2, and two types of coefficients h₀ and h₁ are used in a switched manner. In a case where the parallel number is 8, m=4, and four types of coefficients h₀, h₁, h₂, and h₃ are switched and used. In a case where the parallel number is 16, m=8, and 8 types of coefficients are switched and used. In a case where the parallel number is 32, m=16, and 16 types of coefficients are switched and used.

An input signal of the MIMO filter 171 is represented by u[i]={Xᵢₙ[i], Yᵢₙ[i]}. i indicates an index of the input signal. It is assumed that the input signal u[i] is a signal of double oversampling, that is, a signal of two samples/one symbol. An output signal of the MIMO filter 171 is expressed as v[j]={Xₒᵤₜ[j], Yₒᵤₜ[j]}. j indicates an index of the output signal. The output signal v[j] is assumed to be a signal of one time oversampling, that is, a signal of one sample/one symbol. The output signal v[j] is expressed by the following expression with j|m as a remainder of m with respect to j.

$$v [ j ] = {\sum }_{l} {h}_{j \vert m} \cdot u [ 2 j - l ]$$

The coefficient update unit 172 periodically updates the m types of coefficients based on periodicity based on the parallel number of optical sampling reception. The coefficient update unit 172 updates a coefficient h_{m|j} such that a difference between the output signal v[j] of the MIMO filter 171 and the identification signal relevant to v[j] becomes small. For example, the coefficient update unit 172 calculates an error ∂E between the output signal v[j] and the identification signal for each of the m types of coefficients. The coefficient update unit 172 uses A as a step width in coefficient update, and updates the coefficient h_{j|m} by using the following expression so as to reduce the error.

$${h}_{j \vert m} \to {h}_{j \vert m} - Δ \partial E$$

FIG. 6 is a diagram schematically illustrating MIMO filtering processing in a case where m=2. In the example of FIG. 6, the tap length of the FIR filter is 1=5. The lane number illustrated in FIG. 6 indicates the number of the lane before combining the input signal u[i]. The MIMO filter 171 switches the coefficient h_{j|m} to be applied to the input signal according to the index j of the output signal, and applies the coefficient h_{j|m} to the input signals u[i]to u[i-4].

For example, the coefficient of the MIMO filter 171 is set to h₀={h_{0XX}, h_{0XY}, h_{0YX}, h_{0YY}} for j=0 and j=2. In this case, coefficients of the FIR filters are set as h_{XX}=h_{0XX}, h_{XY}=h_{0XY}, h_{YX}=h_{0YX}, and h_{YY}=h_{0YY}. The coefficient update unit 172 calculates an error ∂E at j=0, and updates the coefficient h₀ used at j=2 by h0→h0−Δ∂E. On the other hand, the coefficient of the MIMO filter 171 is set to h₁={h_{1XX}, h_{1XY}, h_{1YX}, h_{1YY}} for j=1. The coefficient update unit 172 calculates the error ∂E at j=1 and updates the coefficient h₁ by h₁→h₁−Δ∂E. In FIG. 6, the coefficient update unit 172 may update the coefficient h₀ in all j where the index j is j=0, 2, . . . and j|m=0. Alternatively, the update of the coefficient h₀ is not necessarily performed in all j in which j|m=0, and the coefficient update unit 172 may update the coefficient h₀ at an appropriate frequency in accordance with a required circuit scale or a time scale in which a timing mismatch between lanes changes. Similarly, the coefficient update unit 172 may update the coefficient h₁ in all j where the index j is j|m=1, or may update the coefficient h₁ at an appropriate frequency.

Here, the input signal u[i] is a signal obtained by combining pulse reception data subjected to optical sampling reception in parallel in four lanes. In the first example embodiment, the order of the lanes of the period of the tap length 1 of u[i] is the same in each of the case where h₀ is used as the filter coefficient and the case where h₁ is used as the filter coefficient. In FIG. 6, the order of the lanes in a case where h₀ is used is 0→3→2→1→0, and the order of the lanes is the same for v[j] in a case where h₀ is used. The order of the lanes in a case where h₁ is used is 2→1→0→3→2, and the order of the lanes is the same with respect to v[j] in a case where h₁ is used. In the first example embodiment, the coefficient update unit 172 individually updates the coefficient ho and the coefficient h₁. In this way, even in a case where there is a timing mismatch between the lanes, the MIMO processing according to the order of the lanes can be performed by the MIMO filter 171, and the timing mismatch can be compensated. Even in a case where there is a gain difference (signal amplitude difference) between the lanes due to the variation in the signal amplification factor for each device, it is possible to compensate for the gain mismatch between the lanes.

If the same coefficient h is used without switching the coefficients, the order of lanes of the period of the tap length 1 of the input signal u[i] is different between v[0] and v[1]. In FIG. 6, as the order of the lanes, two types of orders of 0→3→2→1→0 and 2→1→0→3→2 are mixed. Therefore, if the coefficient h is updated so that the error decreases at each time, it is considered that the timing mismatch between the lanes cannot be correctly compensated. It is considered that a gain mismatch between the lanes cannot be correctly compensated.

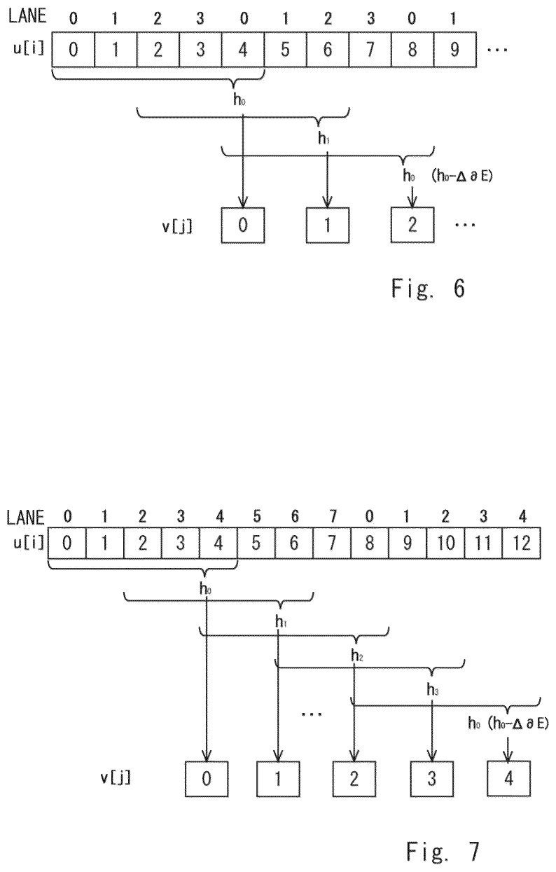

FIG. 7 is a diagram schematically illustrating MIMO filtering processing in a case where m=4. In the example of FIG. 7, the tap length of the FIR filter is 1=5. Coefficients of the MIMO filter 171 are set to h₀ for j=0 and j=4. Coefficients of the MIMO filter 171 are set to h₁ for j=1. Coefficients of the MIMO filter 171 are set to h₂ for j=2. Coefficients of the MIMO filter 171 are set to h₃ for j=3. In this case, similarly to the case of m=2, the order of the lanes of the period of the tap length 1 of u[i] is the same in each of the cases where h₀, h₁, h₂, and h₃ are used. Therefore, by individually updating the coefficients h₀, h₁, h₂, and h₃, the coefficient update unit 172 can compensate for the timing mismatch by the MIMO filter 171 even in a case where there is the timing mismatch between the lanes. Even in a case where there is a gain difference between the lanes, it is possible to compensate for a gain mismatch between the lanes.

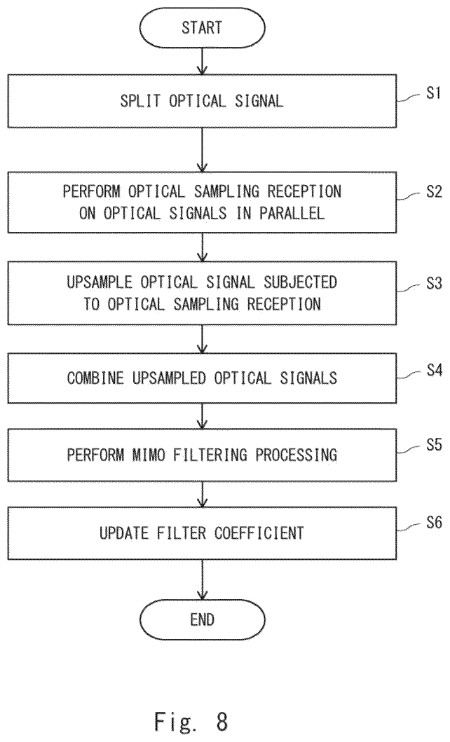

Next, an operation procedure of the optical signal receiver 150 will be described. FIG. 8 is a flowchart illustrating an operation procedure of the optical signal receiver 150. In the optical signal receiver 150, a splitter such as an optical coupler splits the received optical signal into the parallel number optical pulses (step S1). The coherent receivers 153-0 to 153-3 receive the optical signals split in step S1 in parallel by optical sampling by using the optical pulses of the delay times relevant to the lanes (step S2).

The upsampling units 155-0 to 155-3 upsample the reception signal of each lane (step S3). The combiner 157 combines the upsampled reception signals (step S4). The MIMO signal processing circuit 159 performs MIMO filtering processing on the combined reception signal by using the MIMO filter 171 (step S5). The coefficient update unit 172 updates the coefficients of the MIMO filter 171 based on periodicity based on the parallel number in the optical sampling reception (step S6). Steps S5 and S6 are relevant to the signal processing method performed in the MIMO signal processing circuit 159.

The present inventors verified the effect of the first example embodiment by simulation. A 32 Gbaud polarization-multiplexed Quadrature Phase Shift Keying (QPSK) signal has been used for the simulation. The wavelength dispersion in the transmission path has been set to CD=2000 ps/nm. An optical signal-to-noise ratio (OSNR) has been set to 25 dB. The tap length of the MIMO filter 171 is 51 taps. The Error Vector Magnitude (EVM) representing a deviation between the modulated and demodulated symbol position and the identification symbol position has been used to evaluate the reception quality.

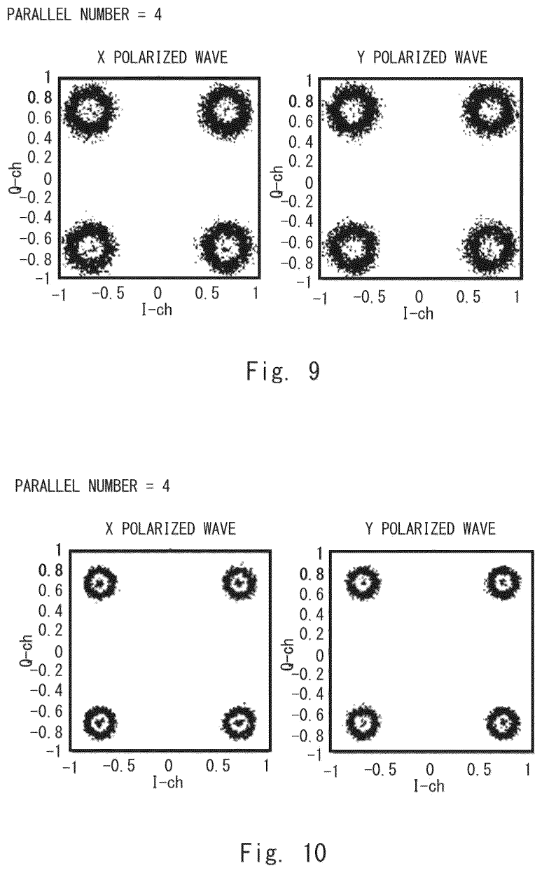

FIGS. 9 and 10 are constellations of the output signal of the optical signal receiver 150 in a case where the parallel number is 4, obtained by simulation. In the simulation, the errors of the delay times of the optical delayers 152-1 to 152-3 are δτ1=−4/32×1 symbol time, δτ2=2/32×1 symbol time, and δτ3=6/32×1 symbol time.

FIG. 9 illustrates a constellation of an output signal in a case where coefficient update is used in a normal MIMO filter. As illustrated in FIG. 9, it can be seen that the spread of the four signal points is large in a case where the coefficient update in the normal MIMO filter is used, that is, in a case where one type of coefficient is updated without depending on the index j of the output signal. In a case where coefficient updating in a normal MIMO filter is used, the EVM has been 15.6%.

FIG. 10 illustrates a constellation of the output signal in a case where the coefficient is updated based on periodicity based on the parallel number of optical sampling reception. As illustrated in FIG. 10, in a case where the two coefficients h₀ and h₁ are periodically updated, the spread of the four signal points is smaller than that in the case of FIG. 9. If the coefficients are updated based on periodicity based on parallel number, the EVM is 9.7%. Therefore, it has been confirmed that the reception characteristics can be improved in the case of using the coefficient update of the MIMO filter 171 in the first example embodiment as compared with the case of using the coefficient update of the normal MIMO filter.

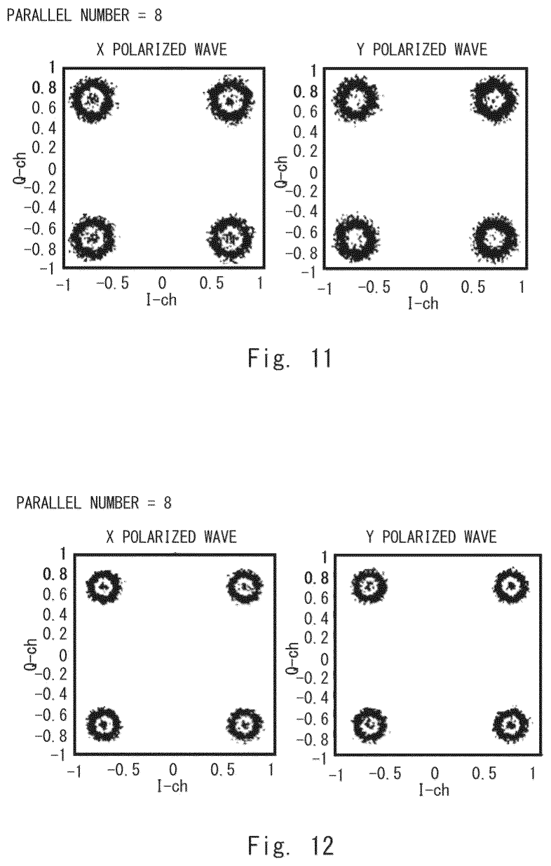

FIGS. 11 and 12 are constellations of the output signal of the optical signal receiver 150 in a case where the parallel number is 8, obtained by simulation. In the simulation, the errors of the delay times of the seven optical delayers are δτ1=−2/32×1 symbol time, δτ2=4/32×1 symbol time, δτ3=0, δτ4=1/32×1 symbol time, δτ5=−4/32×1 symbol time, δτ6=3/32×1 symbol time, and δτ7=4/32×1 symbol time.

FIG. 11 illustrates a constellation of an output signal in a case where coefficient update is used in a normal MIMO filter. As illustrated in FIG. 11, in a case where the coefficient update in the normal MIMO filter is used, it can be seen that the spread of the four signal points is large as in the case of FIG. 9. In a case where the coefficient update in a normal MIMO filter is used, the EVM has been 13.1%.

FIG. 12 illustrates a constellation of the output signal in a case where the coefficient is updated based on periodicity based on the parallel number of optical sampling reception. As illustrated in FIG. 12, it can be seen that, in a case where the four coefficients are periodically updated, the spread of the four signal points is smaller than that in the case of FIG. 11. If the coefficients are updated based on periodicity based on parallel number, the EVM has been 9.9%. Therefore, in the first example embodiment, it has been confirmed that the reception characteristics can be improved even in a case where the parallel number is 8, similarly to a case where the parallel number is 4.

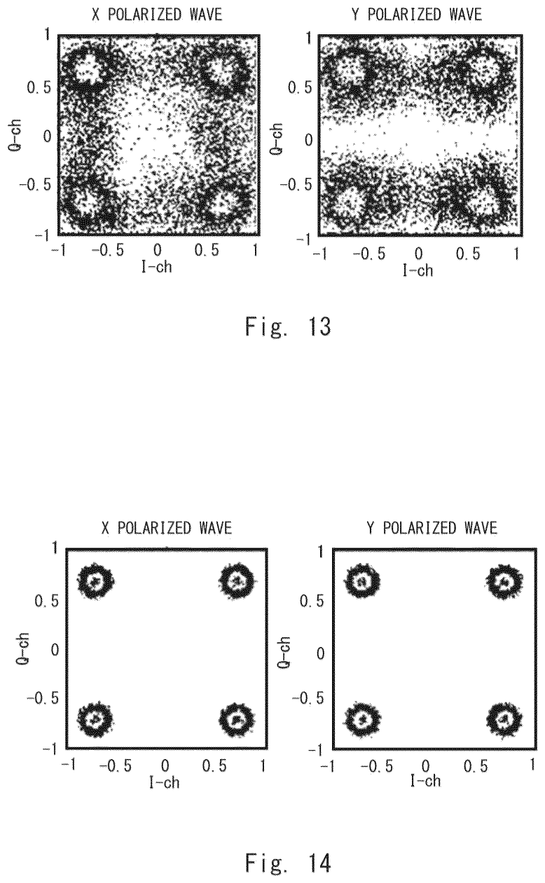

FIGS. 13 and 14 are constellations of the output signal of the optical signal receiver 150 in a case where there is a gain difference between lanes, obtained by simulation. In the simulation, the output signal of the coherent receiver 153-0 has been amplified 1.4 times and the output signal of the coherent receiver 153-1 has been amplified 0.8 times. The output signal of the coherent receiver 153-2 has been amplified 0.9 times, and the output signal of the coherent receiver 153-3 has been amplified 1 time. In the simulation, the errors of the delay times of the optical delayers 152-1 to 152-3 have been set to 0.

FIG. 13 illustrates a constellation of the output signal in a case where coefficient update is used in a normal MIMO filter. As illustrated in FIG. 9, in a case where the coefficient update in the normal MIMO filter is used, it can be seen that the spread of the four signal points is large and the reception characteristics are low due to the gain difference between the lanes. In a case where the coefficient update in a normal MIMO filter is used, the EVM has been 35.8%.

FIG. 14 illustrates a constellation of the output signal in a case where the coefficient is updated based on periodicity based on the parallel number of optical sampling reception. As illustrated in FIG. 14, in a case where the two coefficients h₀ and h₁ are periodically updated, the spread of the four signal points is smaller than that in the case of FIG. 13. If the coefficients are updated based on periodicity based on parallel number, the EVM has been 9.8%. Therefore, in the first example embodiment, it has been confirmed that the gain difference between the lanes can be compensated by the MIMO filter 171 even in a case where there is a gain difference between the lanes.

In the first example embodiment, the MIMO signal processing circuit 159 can compensate for a timing mismatch in optical sampling reception in addition to polarization separation. In the first example embodiment, the reference signal is unnecessary, and the MIMO signal processing circuit 159 can compensate for a timing mismatch that can dynamically change during normal operation of the system. In the first example embodiment, the guard band is unnecessary, and the MIMO signal processing circuit 159 can compensate for a timing mismatch without lowering the band utilization efficiency. Furthermore, in the first example embodiment, the MIMO signal processing circuit 159 can compensate for the gain difference between the lanes and improve the reception characteristics.

Next, a second example embodiment will be described. In the second example embodiment, the MIMO signal processing circuit 159 includes m MIMO filters. In the second example embodiment, the reception signal output from the equalizer 158 is split into m signals, and the split m reception signals are input to the m MIMO filters. In the first example embodiment, m types of coefficients have been switched in one MIMO filter 171, and the m types of coefficients have been updated based on periodicity based on the parallel number of optical sampling reception. On the other hand, in the second example embodiment, the reception signal is split into m MIMO filters, and filtering processing and coefficient update are performed in the m MIMO filters.

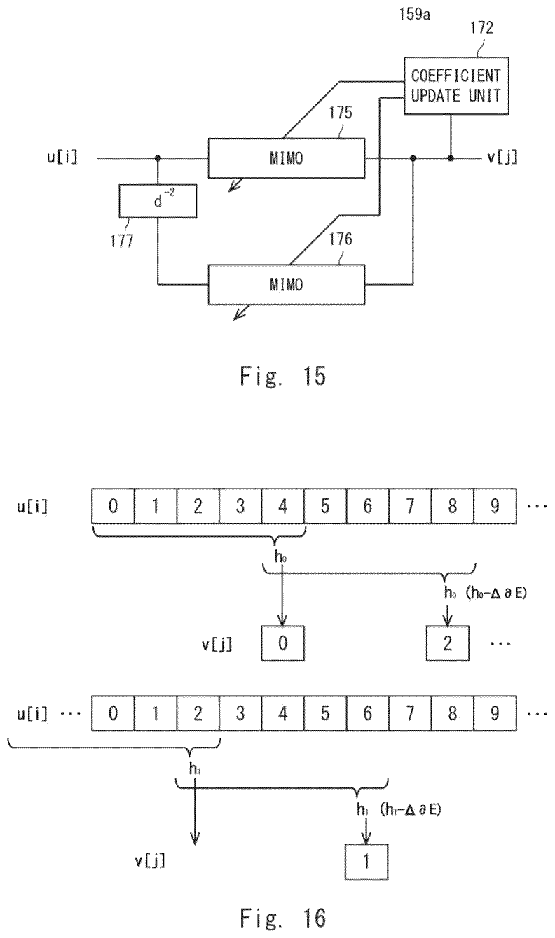

FIG. 15 is a block diagram illustrating a configuration example of a MIMO signal processing circuit. In the example illustrated in FIG. 15, it is assumed that the parallel number of optical sampling reception is 4. A MIMO signal processing circuit 159a illustrated in FIG. 15 includes MIMO filters 175 and 176 and a delay circuit 177. The reception signal output from the equalizer 158 is split into two, and one reception signal is input to the MIMO filter 175. The other one of the split reception signals is input to the delay circuit 177. The delay circuit 177 delays the input reception signal by 2 symbols. The delayed reception signal is input to the MIMO filter 176.

Each of the MIMO filters 175 and 176 is configured as a 2×2 MIMO filter. A coefficient of the MIMO filter 175 is h₀, and a coefficient of the MIMO filter 176 is h₁. The coefficient update unit 172 updates the coefficient h₀ based on the output signal of the MIMO filter 175 and the identification signal. The coefficient update unit 172 updates the coefficient h₁ based on the output signal of the MIMO filter 176 and the identification signal.

FIG. 16 is a diagram schematically illustrating MIMO filtering processing in the MIMO signal processing circuit 159. In the example of FIG. 16, the tap length of the FIR filter of each MIMO filter is 1=5. The MIMO signal processing circuit 159a switches the MIMO filter used in the filtering processing between MIMO filter 175 and MIMO filter 176 according to index j of the output signal. The MIMO filter 175 applies the coefficient h₀ to the input signals u[i] to u[i-4] for j satisfying j|m=0. The MIMO filter 175 applies the coefficient h₁ to the input signals u[i] to u[i-4] for j satisfying j|m=1.

As illustrated in FIG. 16, the MIMO filter 175 applies the coefficient h₀ to the input signal at each of j=0 and j=2. At j=0, the coefficient update unit 172 calculates the error ∂E between the output of the MIMO filter 175 and the identification signal. The coefficient update unit 172 updates the coefficient h₀ used with j=2 by h₀→h₀−Δ∂E. On the other hand, at j=1, the MIMO filter 176 applies the coefficient h₁ to the input signal. At j=1, the coefficient update unit 172 calculates the error ∂E between the output of the MIMO filter 176 and the identification signal. The coefficient update unit 172 updates the coefficient h₁ by h₁→h₁−Δ∂E.

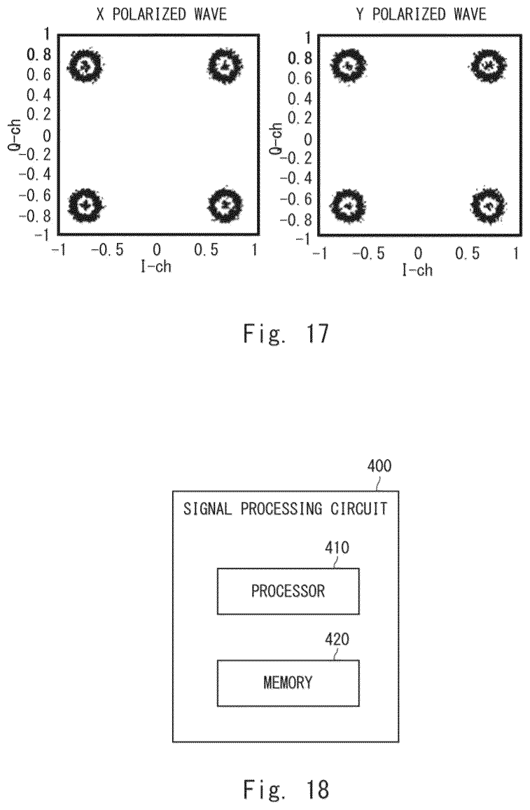

The present inventors verified the effect of the second example embodiment by simulation. Main simulation conditions are similar to the simulation conditions in the simulation described in the first example embodiment. FIG. 17 is a constellation of the output signal of the optical signal receiver in a case where the parallel number is 4, obtained by simulation. In the simulation, the errors of the delay times of the optical delayers 152-1 to 152-3 are δτ1=−4/32×1 symbol time, δτ2=2/32×1 symbol time, and δτ3=6/32×1 symbol time.

In the simulation, the MIMO filter having the coefficient h₀ and the MIMO filter having the coefficient h₁ are periodically switched and used based on the periodicity relevant to the parallel number optical sampling reception. Referring to FIG. 17, it can be seen that the spread of the four signal points is smaller than that in the case of FIG. 9 in which the MIMO filter of one type of coefficient is used. In a case where the MIMO filter with the coefficient h₀ and the MIMO filter with the coefficient h₁ are switched and used, the EVM has been 9.7%. Therefore, also in the second example embodiment, it has been confirmed that the reception characteristics can be improved as compared with the case where the coefficient update of the normal MIMO filter is used.

In the second example embodiment, the MIMO signal processing circuit 159a includes m MIMO filters. In this case, unlike the case of the first example embodiment, the MIMO signal processing circuit 159a does not need to switch m types of coefficients at high speed in one MIMO filter. The filtering processing for the index j in the second example embodiment, that is, the filter operation is the same as the filter operation for the index j in the first example embodiment. Also in the second example embodiment, effects similar to the effects obtained in the first example embodiment can be obtained.

In the first and second example embodiments, the MIMO signal processing circuit 159 can be configured as an arbitrary digital signal processing circuit. FIG. 18 is a block diagram illustrating a configuration example of a signal processing circuit that can be used for the MIMO signal processing circuit 159. The signal processing circuit 400 includes one or more processors 410 and one or more memories 420. The processor 410 reads the program stored in the memory 420 to perform processing such as switching of m types of coefficients in the MIMO filter and coefficient update of the MIMO filter.

The program described above includes commands (or software codes) for causing the processor to perform one or more functions described in the example embodiments in a case where the program is read by the processor. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a compact disc (CD)-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes electrical, optical, or acoustic signals, or propagated signals in other forms.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for describing illustrative example embodiments are not necessarily mandatory, and some features or steps may be omitted. The order of the steps described in any of the figures may be changed as appropriate.

Some or all of the above example embodiments may also be described as the following Supplementary Notes, but are not limited to the following Supplementary Notes.

### [Supplementary Note 1]

A signal processing circuit including:
a multi input multi output (MIMO) filter that performs polarization separation on a reception signal obtained by performing optical sampling reception on optical signals that are polarization multiplexed signals in parallel by using a plurality of local light beams using optical pulses; and
a coefficient update unit that updates a coefficient of the MIMO filter based on periodicity based on a parallel number in the optical sampling reception.

### [Supplementary Note 2]

The signal processing circuit according to Supplementary Note 1, in which
the MIMO filter applies m types of coefficients h₀ to hₘ to the reception signal based on periodicity based on the parallel number, where m is an integer determined according to the parallel number, and
the coefficient update unit individually updates m types of coefficients based on periodicity based on the parallel number.

### [Supplementary Note 3]

The signal processing circuit according to Supplementary Note 2, in which the MIMO filter switches and applies a coefficient h_{j|m} to the reception signal according to an index j of an output signal, where the index of the output signal is j, and j|m is a remainder of m with respect to j.

### [Supplementary Note 4]

The signal processing circuit according to Supplementary Note 3, in which the coefficient update unit updates the coefficient h_{j|m} so as to reduce an error between an output signal of the MIMO filter and an identification signal.

### [Supplementary Note 5]

The signal processing circuit according to Supplementary Note 2, in which the MIMO filter includes m MIMO filters to which the reception signal is split and input.

### [Supplementary Note 6]

The signal processing circuit according to any one of Supplementary Notes 1 to 5, in which the reception signal input to the MIMO filter is a signal obtained by combining a plurality of signals obtained by performing optical sampling reception on the optical signals in parallel by using the optical pulse.

### [Supplementary Note 7]

An optical signal receiving device including:
the signal processing circuit according to any one of Supplementary Notes 1 to 6;
an optical receiver that performs optical sampling reception on the optical signals in parallel by using a plurality of local light beams using the optical pulse; and
a combiner that combines a plurality of signals obtained by the optical receiver performing optical sampling reception on the optical signals in parallel, and inputs the combined plurality of signals to the signal processing circuit as the reception signal.

### [Supplementary Note 8]

The optical signal receiving device according to Supplementary Note 7, in which the optical receiver includes:
a pulsed light source that outputs the optical pulse at a predetermined repetition period; and
an optical delayer that generates the plurality of local light beams by delaying the optical pulse output from the pulse light source by a delay time determined according to the repetition period and the parallel number.

### [Supplementary Note 9]

A signal processing method including:
performing, using a multi input multi output (MIMO) filter, polarization separation on a reception signal obtained by performing optical sampling reception on optical signals that are polarization multiplexed signals in parallel by using a plurality of local light beams using optical pulses; and
updating a coefficient of the MIMO filter based on periodicity based on a parallel number in the optical sampling reception.

### [Supplementary Note 10]

A program for causing a processor to execute processes of:
performing, using a multi input multi output (MIMO) filter, polarization separation on a reception signal obtained by performing optical sampling reception on optical signals that are polarization multiplexed signals in parallel by using a plurality of local light beams using optical pulses; and
updating a coefficient of the MIMO filter based on periodicity based on a parallel number in the optical sampling reception.

Some or all of the elements (such as configurations and functions, for example) described in Supplementary Notes 2 to 6 depending from Supplementary Note 1 may depend from Supplementary Notes 9 and 10 as well with depending relationships similar to those of Supplementary Notes 2 to 6. Some or all of the elements described in any Supplementary Note may be applied to various types of hardware, software, recording means for recording software, systems, and methods.

1. A signal processing circuit comprising:
a multi input multi output (MIMO) filter that performs polarization separation on a reception signal obtained by performing optical sampling reception on optical signals that are polarization multiplexed signals in parallel by using a plurality of local light beams using optical pulses;
a memory storing instructions; and
a processor configured to execute the instructions to update a coefficient of the MIMO filter based on periodicity based on a parallel number in the optical sampling reception.

2. The signal processing circuit according to claim 1, wherein
the MIMO filter applies m types of coefficients h₀ to hₘ to the reception signal based on periodicity based on the parallel number, where m is an integer determined according to the parallel number, and
the processor is configured to execute the instructions to individually update m types of coefficients based on periodicity based on the parallel number.

3. The signal processing circuit according to claim 2, wherein the MIMO filter switches and applies a coefficient h_{j|m} to the reception signal according to an index j of an output signal, where the index of the output signal is j, and j|m is a remainder of m with respect to j.

4. The signal processing circuit according to claim 3, wherein the processor is configured to execute the instructions to update the coefficient h_{j|m} so as to reduce an error between an output signal of the MIMO filter and an identification signal.

5. The signal processing circuit according to claim 2, wherein the MIMO filter includes m MIMO filters to which the reception signal is split and input.

6. The signal processing circuit according to claim 1, wherein the reception signal input to the MIMO filter is a signal obtained by combining a plurality of signals obtained by performing optical sampling reception on the optical signals in parallel by using the optical pulse.

7. An optical signal receiving device comprising:
a signal processing circuit comprising:
a multi input multi output (MIMO) filter that performs polarization separation on a reception signal obtained by performing optical sampling reception on optical signals that are polarization multiplexed signals in parallel by using a plurality of local light beams using optical pulses;
a memory storing instructions; and
a processor configured to execute the instructions to update a coefficient of the MIMO filter based on periodicity based on a parallel number in the optical sampling reception;
an optical receiver that performs optical sampling reception on the optical signals in parallel by using a plurality of local light beams using the optical pulse; and
a combiner that combines a plurality of signals obtained by the optical receiver performing optical sampling reception on the optical signals in parallel, and inputs the combined plurality of signals to the signal processing circuit as the reception signal.

8. The optical signal receiving device according to claim 7,
wherein the optical receiver comprises:
a pulsed light source that outputs the optical pulse at a predetermined repetition period; and
an optical delayer that generates the plurality of local light beams by delaying the optical pulse output from the pulse light source by a delay time determined according to the repetition period and the parallel number.

9. A signal processing method comprising:
performing, using a multi input multi output (MIMO) filter, polarization separation on a reception signal obtained by performing optical sampling reception on optical signals that are polarization multiplexed signals in parallel by using a plurality of local light beams using optical pulses; and
updating a coefficient of the MIMO filter based on periodicity based on a parallel number in the optical sampling reception.
